(19) United States
(12) Patent Application Publication
(10) Pub. No.: US 2025/0003461 A1
(43) Pub. Date: Jan. 2, 2025

(54) BRAKING SYSTEM WITH BALANCED ACTUATION

(71) Applicant: HITACHI ASTEMO FRANCE, Drancy (FR)

(72) Inventors: Antony AUGUSTE, Villiers-Sur-Marne (FR); Philippe BOURLON, DAMMARTIN EN GOELE (FR)

(21) Appl. No.: 18/710,690

(22) PCT Filed: Oct. 26, 2022
(86) PCT No.: PCT/EP2022/080013

§ 371 Date: May 16, 2024

(30) Foreign Application Priority Data
Dec. 3, 2021 (FR) FR2112959

(51) Int. Cl. F16D 65/00; B60T 13/58; F16D 55/00; F16D 55/226; F16D 65/18; F16D 121/04; F16D 121/24; F16D 125/40; F16D 127/00

(52) U.S. Cl. CPC F16D 65/005; B60T 13/588; F16D 55/226; F16D 65/183; F16D 2055/0066; F16D 2055/0091; F16D 2121/04; F16D 2121/24; F16D 2125/40; F16D 2127/00

(57) ABSTRACT

A clamping device for a braking system including a caliper supporting at least two hydraulic actuators each configured to provide a clamping force in order to force friction elements together, and at least one electric actuator which is configured to provide the clamping force and coupled to a mechanism for converting the rotational movement of an output shaft of the electric actuator into a translational movement in order to force the friction elements together. The clamping device includes a mechanism for balancing the clamping forces of the hydraulic and electric actuators which adapts the orientation of at least one of the friction elements according to its wear, regardless of the type of actuation used.

### TECHNICAL FIELD OF THE INVENTION

The invention relates to the field of braking systems for vehicles, more particularly the field of braking systems of the hydraulic type with electric parking brake.

### TECHNICAL BACKGROUND OF THE INVENTION

A braking system for a vehicle, in particular a motor vehicle, generally comprises mechanical clamping devices comprising in particular friction elements, such as brake pads, connected to an actuator adapted to move a pair of these friction elements towards two opposite sides of a disc attached to a wheel of the vehicle to clamp it and thus brake the vehicle by friction of the friction elements against the disc, or move them away in order to stop braking.

In the case of hydraulic braking systems, the mechanical clamping devices comprise at least one piston actuated (pushed or pulled) along an axial direction by the displacement of an actuation fluid controlled by the movements of the vehicle brake pedal. In the particular case of mechanical clamping devices with several pistons, several clamping points are actuated on the same friction element along parallel axial directions at the same time.

As the braking system is used, the friction elements wear out due to friction against the disc. Since braking occurs mainly when the vehicle is moving forward, the friction elements wear more quickly on a leading part of the friction elements (in the direction of rotation of the disc when the vehicle is moving forward). The friction elements therefore become more and more asymmetrical each time the vehicle brakes.

Thus, in the particular case of mechanical clamping devices with several pistons, the leading part of the friction elements (in the direction of rotation of the disc when the motor vehicle is moving forward) corresponds to one of the two clamping points relative to the other. It may then become difficult to balance the braking (left/right and/or front/rear) or the pistons may even lock together due to the friction elements which are no longer parallel to the sides of the braking disc.

Nowadays, vehicles are also more and more frequently equipped with an electric parking brake (EPB). The hydraulic actuation must therefore be combined with electromechanical actuation in order, in the same way as hydraulic actuation, to move the pair of friction elements towards two opposite sides of the disc and thus brake the vehicle by friction of the friction elements against the disc, or move them away in order to stop parking braking.

In the particular case of mechanical clamping devices with several pistons, it is therefore understood that the installation of the electric parking brake is even more complex. In addition, we are faced with the same problem of balancing the locking braking due to the friction elements which are no longer perfectly parallel to the sides of the braking disc.

### SUMMARY OF THE INVENTION

The invention aims in particular to propose a clamping device for a vehicle braking system which combines several hydraulic braking actuators and one electric actuator of an electric parking brake while permanently maintaining a braking balance equivalent to that of braking with new friction elements, in other words not worn.

The invention therefore relates to a clamping device for a braking system intended to exert a relative displacement between friction elements and comprising a caliper supporting at least two hydraulic actuators each intended to provide a clamping force in order to force a relative displacement movement between the friction elements along an axial rectilinear direction, and at least one electric actuator, intended to provide the clamping force and coupled to a mechanism for converting the rotational movement of an output shaft of the electric actuator into a translational movement in order to force a relative displacement movement between the friction elements along an axial rectilinear direction, characterised in that the clamping device comprises a mechanism for balancing the clamping forces of the hydraulic and electric actuators which adapts the orientation of at least one of the friction elements according to its wear, regardless of the type of actuation used.

Advantageously according to the invention, the balancing mechanism offers the same balanced clamping with hydraulic multi-actuation as with electric actuation, in other words even if the force with hydraulic actuation is greater and at several points compared with that of electric actuation.

In addition, the balancing mechanism is capable, advantageously according to the invention, of adapting its geometry according to the wear of the friction elements in order to keep a surface of the friction elements substantially parallel relative to each side of the braking disc when braking.

The invention may also comprise one or more of the following optional characteristics, taken alone or in combination.

The clamping mechanism comprises a force transmission element mounted between the hydraulic and electric actuators and the friction element in order to receive the clamping forces of the hydraulic and electric actuators to selectively redistribute them in a balanced manner to the friction element. Advantageously according to the invention, a single element receives all the clamping forces, in other words those of the hydraulic actuation at several points and that of the electric actuation in order to balance the braking more easily.

The force transmission element comprises a plate that is articulated relative to at least one of the hydraulic and electric actuators in order to adapt the orientation of the friction element according to its wear, regardless of the type of actuation used. It is understood that the transmission element is therefore capable, by the articulation, of changing its orientation relative to the axial direction of each actuation force in order to orient the contact surface of the friction elements with the braking disc when braking to maximize the substantially parallel friction area of the friction elements relative to each side of the braking disc when braking.

The plate is thus preferably articulated by a socket connection with clearance in order to only allow rotation about an axis perpendicular to the axial rectilinear direction relative to the electric actuator and by a flat support connection relative to each of the hydraulic actuators in order to adapt the orientation of the friction element according to its wear, regardless of the type of actuation used. The single electric actuator is chosen as the articulation point which therefore drives the transmission element and/or is driven by the hydraulic actuators.

The force transmission element redistributes the clamping forces by at least two spherical pin connections to the friction element in order to adapt the orientation of the friction element according to its wear. The two articulation points of the friction element provide, at two places, two degrees of freedom in rotation to adapt to any difference in parallelism between the contact surface of the friction element and the side of the braking disc.

The force transmission element receives the clamping force of the electric actuator between the clamping forces of the hydraulic actuators in order to facilitate the balanced redistribution of the clamping forces to the friction element. Each end of the friction element is in fact driven by a hydraulic actuator and, between these two hydraulic clamping points, a single clamping point of the electric actuator is arranged in order to achieve equivalent balancing for each type of braking that is easier to obtain.

The invention also relates to a braking system for a vehicle comprising a pair of friction elements intended to cooperate by friction with a disc, characterised in that it comprises a clamping device as described above arranged to move the pair of friction elements towards two opposite sides of the disc in order to clamp it. The braking system is preferably of the floating caliper disc brake type.

Lastly, the invention relates to a vehicle characterised in that it comprises a braking system as described above.

### BRIEF DESCRIPTION OF THE DRAWINGS

Other features and advantages of the invention will appear clearly on reading the description which follows, given by way of example and not limiting in any way, referring to the attached drawings, in which:

FIG. 1 is a schematic plan view of a vehicle in which a braking system according to the invention is mounted;

FIG. 2 is a schematic view of a braking system according to the invention;

FIG. 3 is a perspective view of a clamping device according to the invention;

FIG. 4 is a schematic plan view of a part of the braking system showing a balancing mechanism according to the invention;

FIG. 5 is a schematic plan view of a balancing mechanism in the rest position according to the invention;

FIG. 6 is a schematic plan view of a balancing mechanism in the electric actuation position according to the invention;

FIG. 7 is a schematic plan view of a balancing mechanism in the double hydraulic actuation position according to the invention;

FIG. 8 is a schematic plan view of a balancing mechanism in the electric actuation and double hydraulic actuation position according to the invention;

FIG. 9 is a schematic plan view of a balancing mechanism in the rest position according to the invention, the friction element being asymmetrical due to wear;

FIG. 10 is a schematic plan view of a balancing mechanism in the electric actuation position according to the invention, the friction element being asymmetrical due to wear;

FIG. 11 is a schematic plan view of a balancing mechanism in the double hydraulic actuation position according to the invention, the friction element being asymmetrical due to wear;

FIG. 12 is a perspective view of a part of the braking system showing an example of a transmission element according to the invention;

FIG. 13 is a perspective view of the example of a transmission element according to the invention coupled to an example of a conversion mechanism;

FIG. 14 is a perspective view of a part of the example of a transmission element according to the invention.

### DETAILED DESCRIPTION OF AT LEAST ONE EMBODIMENT OF THE INVENTION

In the remainder of the document, the orientations are the orientations of the figures. In particular, the terms “upper”, “lower”, “left”, “right”, “above”, “below”, “forward” and “backward” generally mean with respect to the direction of representation of the figures. However, we also mention:
an axial direction A, coinciding with the central thrust axis of the friction elements 2a, 2b;
a radial direction R, perpendicular to the axial direction A, passing through a radius in the median plane of the disc 3; and
a tangential direction T, perpendicular to the axial direction A, resulting from the friction by the friction elements 2a, 2b moving towards the axial direction A pressing against the disc 3 rotating about an axis parallel to the axial direction A and attached to a wheel 5 of a vehicle 4.

The invention applies to all types of braking system 1, in particular those intended to be fitted on motor vehicles 4 such as private vehicles, SUVs (Sport Utility Vehicles), two-wheeled vehicles (in particular motorcycles), aeroplanes, industrial vehicles selected from vans, “heavy goods vehicles”—in other words metro, bus, road transport vehicles (trucks, tractors, trailers), off-road vehicles such as agricultural or civil engineering vehicles—, or other transport or handling vehicles. The invention also applies to non-motorised vehicles such as in particular a trailer, a semi-trailer or a caravan.

“Braking system 1” means all types of braking system 1 comprising several hydraulic actuators 18a, 18b and at least one electric actuator 12 each intended to move friction elements 2a, 2b towards each other in order to clamp the sides of a disc 3 attached to a wheel 5 of a vehicle 4 to brake it.

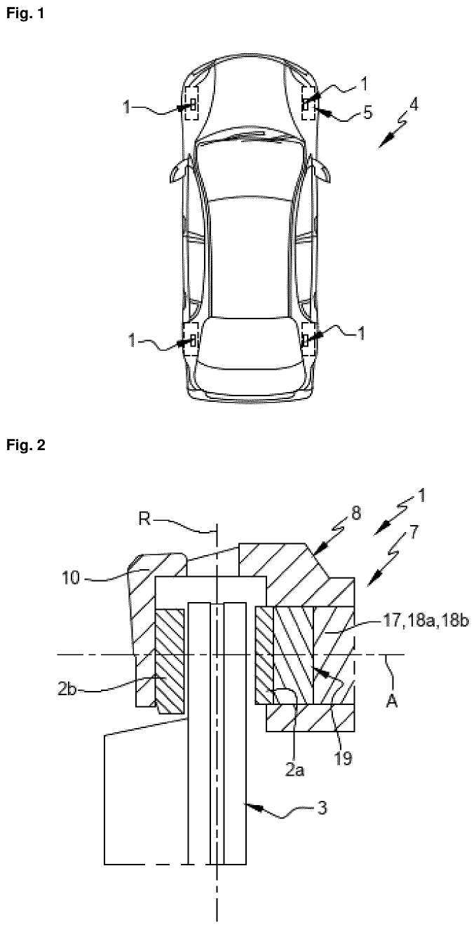

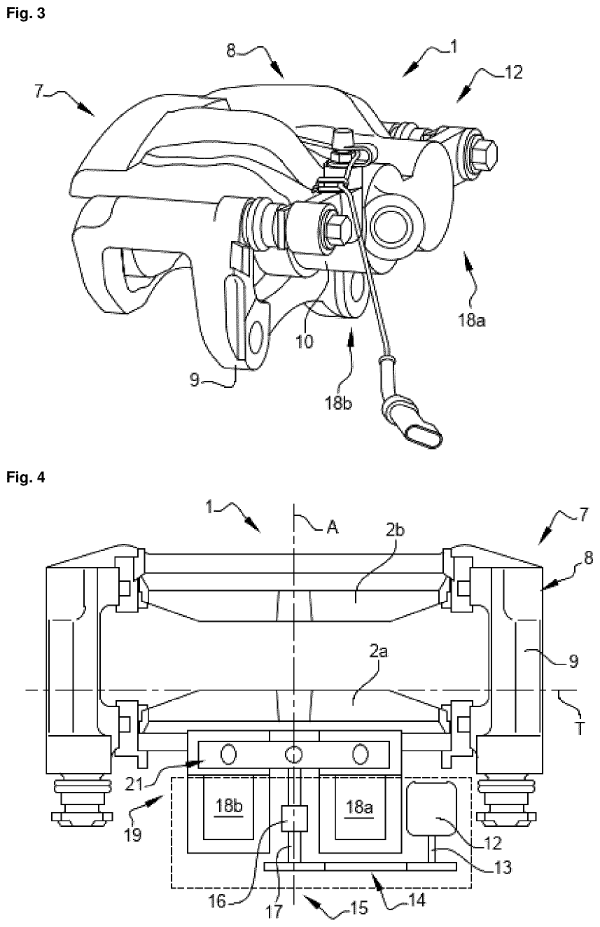

In the examples of FIGS. 2 to 3, a braking system 1 with a floating caliper type clamping device 7 is used, in other words an assembly 8, or brake, comprises the actuators 12, 18a, 18b on one side only, consists of a carrier 9 fixed relative to the vehicle 4 and a caliper 10 movable relative to the carrier 9, and is arranged to move the friction element 2b towards the friction element 2a when the latter is in contact with the disc 3. Such a floating caliper type clamping device 7 requires the use of fewer actuators 12, 18a, 18b and is therefore more compact than a fixed caliper type clamping device 7.

Obviously, the invention also applies to a braking system 1 with a fixed caliper type clamping device 7, in other words an assembly 8, consisting of a caliper 10 fixed relative to the vehicle 4, comprises one or more actuators 12, 18a, 18b for each element 2a, 2b on each side of the disc 3 to move the friction elements 2a, 2b respectively towards each other in order to come into contact with the disc 3.

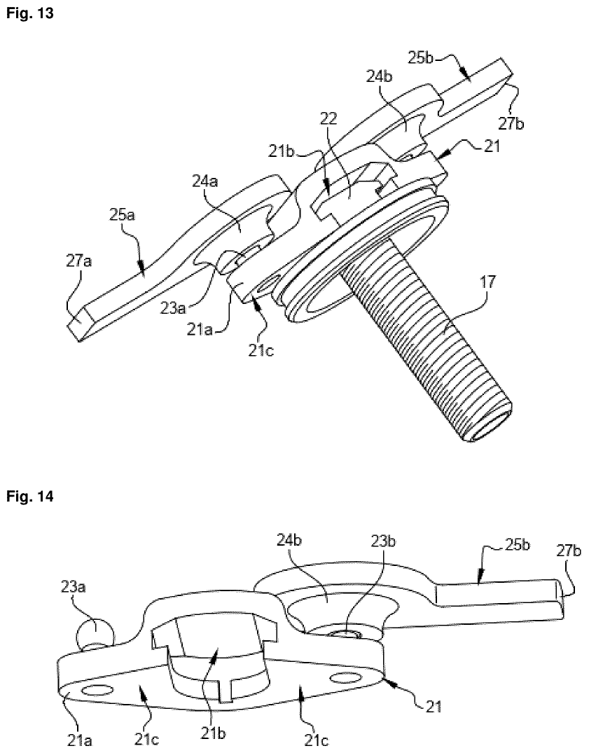

In the example shown on FIGS. 2 to 14, the clamping device 7 further comprises all the associated power and control members in order, in particular, to manage the clamping amplitude and force.

The caliper 10 is also fitted with a mechanism 15 for converting the rotational movement of an output shaft 13 of the electric actuator 12 into a translational movement along the axial direction A (or a parallel direction). In the example shown on FIG. 4, the conversion mechanism 15 is coupled to the electric actuator 12 using a reduction gear 14. A relative displacement movement is therefore obtained between the friction elements 2a, 2b along a substantially axial rectilinear direction A. In the examples shown on FIGS. 4 to 14, the conversion mechanism 15 is of the screw 17—nut 16 type so as, when each electric actuator 12 is off, to oppose any movement of the friction elements 2a, 2b, such as, for example, when the electric parking brake is active to immobilise the vehicle 4 when parking. In a known manner, the hydraulic actuators 18a, 18b form pistons connected to the hydraulic braking network (not shown) in order to be pushed or pulled along the axial direction A (or a parallel direction) by the movement of an actuation fluid controlled by the movements of the vehicle 4 brake pedal in the usual way.

Advantageously according to the invention, the clamping device 7 comprises a mechanism 19 for balancing the clamping forces of the hydraulic 18a, 18b and electric 12 actuators which adapts the orientation of at least one 2a of the friction elements 2a, 2b according to its wear, regardless of the type of actuation used, in other words whether the actuation is hydraulic (the two actuators 18a, 18b at the same time) and/or electric (actuator 12 alone). Thus, the balancing mechanism 19 provides equivalent balanced clamping despite the difficulty induced by hydraulic multi-actuation and/or electric actuation, in other words even if the force with hydraulic actuation is greater and at several points compared with that of electric actuation.

In addition, the balancing mechanism 19 is capable, advantageously according to the invention, of adapting its geometry according to the wear of the friction elements 2a, 2b in order to keep a surface of the friction elements 2a, 2b substantially parallel relative to each side of the braking disc 3 when braking.

The clamping mechanism 19 comprises a force transmission element 21 mounted between the hydraulic 18a, 18b and electric 12 actuators and the friction element 2a in order to receive the clamping forces of the hydraulic 18a, 18b and electric 12 actuators to selectively redistribute them in a balanced manner to the friction element 2a. Advantageously according to the invention, a single element 21 receives all the clamping forces, in other words those of the hydraulic actuation at several points (the two actuators 18a, 18b at the same time) and that of the electric actuation (actuator 12 alone) in order to facilitate the balancing of the braking.

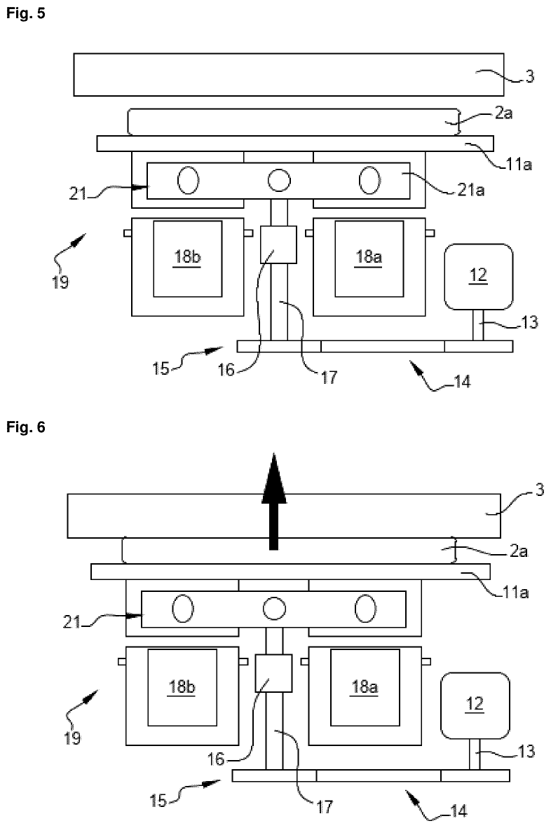

The force transmission element 21 comprises a plate 21a that is articulated relative to at least one of the hydraulic 18a, 18b and electric 12 actuators in order to adapt the orientation of the friction element 2a by actuating its support 11a according to its wear, regardless of the type of actuation used. It is understood that the transmission element 21 is therefore capable, by the articulation, of changing its orientation relative to the axial direction A of each actuation force (the two actuators 18a, 18b at the same time and/or the actuator 12 alone) in order to orient the contact surface of the friction elements 2a, 2b with the braking disc 3 when braking to maximize the substantially parallel friction area of the friction elements 2a, 2b relative to each side of the braking disc 3 when braking as will be more clearly explained below using FIGS. 5 to 11.

The plate 21a is thus preferably articulated by a socket connection with clearance in order to only allow rotation about an axis (parallel to the radial axis R, shown on FIG. 2) perpendicular to the axial rectilinear direction (A) relative to the electric actuator 12 and, more precisely, to the free end of the screw 17 of the conversion mechanism 15. In the example shown on FIGS. 12 to 14, the socket connection with clearance is obtained by a trapezoidal prism forming a polygonal ball joint 22, pivotally mounted in the extension of the free end of the screw 17, and received in a ball joint seat 21b formed in the transmission element 21. It is therefore understood that the rotations relative to the axial axis A and to the tangential axis T (shown on FIG. 4) are made impossible by the complementarity of the shapes between the ball joint 22 and the ball joint seat 21b. However, a predetermined rotation, in other words through a limited angle of rotation, about an axis (parallel to the radial axis R, shown on FIG. 2) perpendicular to the axial rectilinear direction A is possible thanks to a clearance left in the complementarity of the shapes between the polygonal ball joint 22 and the ball joint seat 21b at the non-parallel faces of the trapezoidal prism. The single electric actuator 12, and more precisely the end of the screw 17, is chosen as the articulation point which therefore drives the force transmission element 21 and/or is driven by the hydraulic actuators 18a, 18b. When only the actuators 18a, 18b are used, the end of the screw 17 is free to move along the axial direction A but the end of the screw 17 can push the transmission element 21 when the electric actuator 12 is activated.

The plate 21a also preferably comprises a flat support connection relative to each of the hydraulic actuators 18a, 18b in order to adapt the orientation of the friction element 2a according to its wear, regardless of the type of actuation used (the two actuators 18a, 18b at the same time and/or the actuator 12 alone). In the example shown on FIGS. 12 to 14, each flat support connection is obtained by the contact between one of the two flat surfaces 21c of the plate 21a with the free end of one of the pistons of each hydraulic actuator 18a, 18b. It is therefore understood that each hydraulic actuator 18a, 18b pushes, at the same time and independently, against a flat surface 21c of the plate 21a along the axial axis A (or a direction parallel to the axial axis A) when hydraulic braking is controlled.

The force transmission element 21 redistributes the clamping forces by at least two spherical connections to the friction element 2a in order to adapt the orientation of the friction element 2a according to its wear. The two articulation points of the friction element provide, at two places, two degrees of freedom in rotation to adapt to any difference in parallelism between the contact surface of the friction element 2a and the side of the braking disc 3 as will be more clearly explained below using FIGS. 5 to 14. In the example shown on FIGS. 12 to 14, each spherical connection is obtained by a spherical ball joint 23a, 23b, mounted inserted in the plate 21a on the side opposite a flat surface 21c, received in a ball joint seat 24a, 24b formed in a guide element 25a, 25b.

It is therefore understood that no rotation is limited but only the translations as is the case with a typical spherical connection. Lastly, as shown on FIG. 12, the guide elements 25a, 25b are preferably mounted on the same translation rails 26a, 26b as the friction element 2a, in other words slidably mounted on the carrier 9. More precisely, the guide ends 27a, 27b of the guide elements 25a, 25b cooperate by slide connections with respectively the translation rails 26a, 26b as will be more clearly explained below using FIGS. 5 to 11.

The force transmission element 21 preferably receives the clamping force of the electric actuator 12 between the clamping forces of the hydraulic actuators 18a, 18b in order to facilitate the balanced redistribution of the clamping forces to the friction element 2a. Each end of the friction element 2a is in fact driven by a hydraulic actuator 18a, 18b and, between these two hydraulic clamping points, at the seats 24a, 24b of the spherical ball joints 23a, 23b, a single clamping point of the electric actuator 12 is arranged at the seat 21b of the polygonal ball joint 22 in order to achieve equivalent balancing for each type of braking that is easier to obtain.

The operation of the invention will now be explained in reference to FIGS. 5 to 11. FIGS. 5 to 8 show the operation of the braking system 1 according to the invention with new friction elements 2a, 2b, in other words not worn. FIG. 5 is a schematic plan view of a balancing mechanism 19 in the rest position according to the invention, in other words neither hydraulic actuation (actuators 18a, 18b) nor electric actuation (actuator 12) is used. The friction element 2a and, incidentally, the friction element 2b, is not in contact with a side of the braking disc 3. The motor vehicle 4 is therefore not braked by the braking system 1.

If the user wants to immobilise their vehicle 4 when parked, they activate the electric parking brake. The actuator 12 is then activated and drives the conversion mechanism 15 via the reduction gear 14 in order to push the force transmission element 21. By moving, the force transmission element 21 imposes a translation along the axial direction A and brings the friction element 2a into contact against a first side of the disc 3 then finally the friction element 2b against a second side of the disc 3 so that the braking system 1 is locked to the disc 3 by friction. FIG. 6 shows this purely electric actuation position according to the invention. We can see in particular that the hydraulic actuators 18a, 18b remained away from the force transmission element 21.

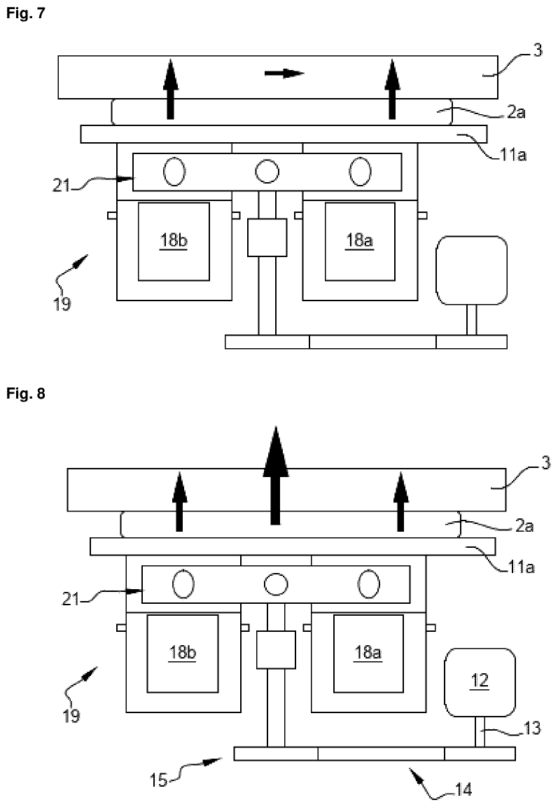

If the user wants to brake their vehicle 4 when moving, they press the hydraulic brake pedal. The two actuators 18a, 18b are then activated at the same time in order to push the force transmission element 21. By moving, the force transmission element 21 imposes a translation along the axial direction A and brings the friction element 2a into contact against a first side of the disc 3 then finally the friction element 2b against a second side of the disc 3 so that the braking system 1 is locked to the disc 3 by friction. FIG. 7 shows this purely hydraulic actuation position according to the invention. If the friction elements 2a, 2b are not or only slightly worn, braking at two points generated respectively by the two actuators 18a, 18b places little or no stress on the connection between the conversion mechanism 15 and the force transmission element 21.

Obviously, if electric actuation alone is activated, it remains possible to activate hydraulic actuation as shown on FIG. 8. Similarly, if hydraulic actuation alone is activated, it remains possible to activate electric actuation as shown on FIG. 8, except that the speed of the vehicle 4 must be checked to avoid sudden, potentially dangerous, braking.

Consequently, the force balancing mechanism 19, regardless of the actuation mode, in other words whether actuation is hydraulic (the two actuators 18a, 18b at the same time) and/or electric (actuator 12 alone), guarantees equivalent balanced braking of the vehicle 4 despite the difficulty induced by hydraulic multi-actuation and/or electric actuation, in other words even if the force with hydraulic actuation is greater and at several points compared with that of electric actuation.

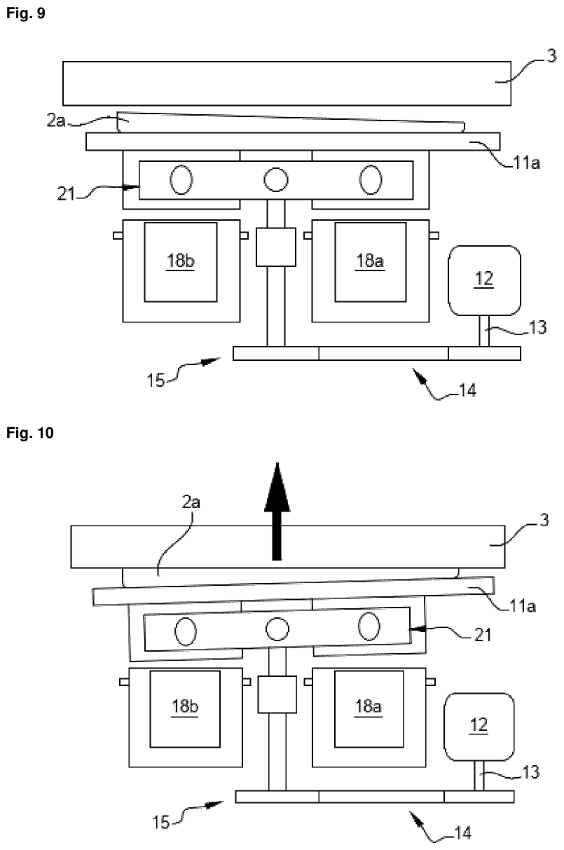

FIGS. 9 to 11 show the operation of the braking system 1 according to the invention with friction elements 2a, 2b worn asymmetrically. Since hydraulic braking using the brake pedal occurs mainly when the vehicle 4 is moving forward, the friction elements 2a, 2b wear more quickly on a leading part of the friction elements 2a, 2b (in the direction of rotation of the disc 3 when the vehicle 4 is moving forward). The friction elements 2a, 2b therefore become more and more asymmetrical each time the vehicle brakes. FIG. 6 is a schematic plan view of a balancing mechanism 19 in the rest position according to the invention, in other words neither hydraulic actuation (actuators 18a, 18b) nor electric actuation (actuator 12) is used. The friction element 2a and, incidentally, the friction element 2b, are not in contact with a side of the braking disc 3. The motor vehicle 4 is therefore not braked by the braking system 1. We can see that element 2a is thicker on the left of the figure than on the right in order to show the asymmetrical wear.

If the user wants to immobilise their vehicle 4 when parked, they activate the electric parking brake. The actuator 12 is then activated and drives the conversion mechanism 15 via the reduction gear 14 in order to push the force transmission element 21. By moving, the force transmission element 21 imposes a translation along the axial direction A and brings the friction element 2a into contact against a first side of the disc 3 then finally the friction element 2b against a second side of the disc 3 so that the braking system 1 is locked to the disc 3 by friction. Advantageously according to the invention, the balancing mechanism 19 is capable of adapting its geometry according to the wear of the friction elements 2a, 2b in order to keep a surface of the friction elements 2a, 2b substantially parallel relative to each side of the braking disc 3 when braking.

FIG. 10 shows the stress on the connection between the conversion mechanism 15 and the force transmission element 21 allowing a geometric adaptation to the actual wear of the friction elements 2a, 2b in order to guarantee a maximum friction area of the friction elements 2a, 2b substantially parallel relative to each side of the braking disc 3 when braking. Thus, the braking balance will be maintained between the new condition and the completely worn condition of the friction elements 2a, 2b.

If the user wants to brake their vehicle 4 when moving, they press the hydraulic brake pedal. The two actuators 18a, 18b are then activated at the same time in order to push the force transmission element 21. By moving, the force transmission element 21 imposes a translation along the axial direction A and brings the friction element 2a into contact against a first side of the disc 3 then finally the friction element 2b against a second side of the disc 3 so that the braking system 1 is locked to the disc 3 by friction. Advantageously according to the invention, the balancing mechanism 19 is capable of adapting its geometry according to the wear of the friction elements 2a, 2b in order to keep an area of the friction elements 2a, 2b substantially parallel relative to each side of the braking disc 3 when braking.

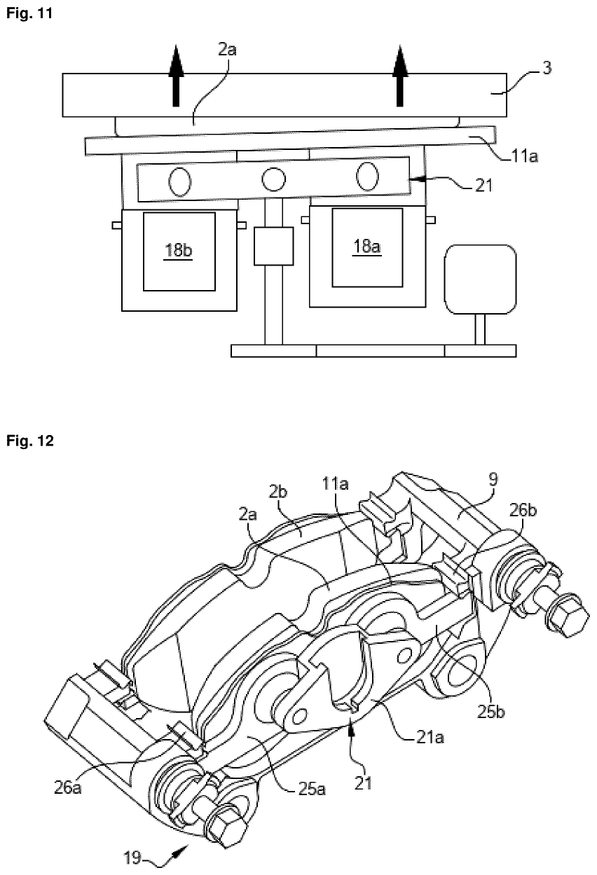

FIG. 11 shows the stress on the connection between the conversion mechanism 15 and the force transmission element 21 allowing a geometric adaptation to the actual wear of the friction elements 2a, 2b in order to guarantee a maximum friction area of the friction elements 2a, 2b substantially parallel relative to each side of the braking disc 3 when braking. Thus, the braking balance will be maintained between the new condition and the completely worn condition of the friction elements 2a, 2b. Note that the difference in wear of the friction element 2a means that the hydraulic actuator 18a on the right must travel further than the hydraulic actuator 18b on the left. However, thanks to the balancing mechanism 19, no frictional locking movement will, advantageously according to the invention, be generated by this difference in travel.

In addition, if electric actuation alone is activated, it remains possible to activate hydraulic actuation. Similarly, if hydraulic actuation alone is activated, it remains possible to activate electric actuation, except that the speed of the vehicle 4 must be checked to avoid sudden, potentially dangerous, braking.

Consequently, the force balancing mechanism 19, regardless of the actuation mode, in other words whether actuation is hydraulic (the two actuators 18a, 18b at the same time) and/or electric (actuator 12 alone), guarantees equivalent balanced braking of the vehicle 4 despite the difficulty induced by hydraulic multi-actuation and/or electric actuation, and asymmetrical wear of the friction element 2a, 2b.

The invention is not limited to the embodiments and variants described and other embodiments and variants will be clearly apparent to those skilled in the art. Thus, the embodiments and variants can be combined together without departing from the scope of the invention. As a non-limiting example, other types of connection can be used to obtain the adaptation of the orientation of at least one of the friction elements according to its wear such as, for example, in particular between the transmission element 21 and the conversion mechanism 15 without departing from the scope of the invention.

### LIST OF REFERENCES

1-braking system
2a-friction element
2b-friction element
3-disc
4-vehicle
5-wheel
7-clamping device
8-assembly
9-carrier
10-calliper
11a-support of the friction element 2a
12-electric actuator
13-output shaft
14-reduction gear
15-conversion mechanism
16-nut
17-screw
18a-first hydraulic actuator
18b-second hydraulic actuator
19-balancing mechanism
21-force transmission element
21a-plate
21b-seat of the polygonal ball joint
21c-flat surface
22-polygonal ball joint
23a-first spherical ball joint
23b-second spherical ball joint
24a-first spherical ball joint seat
24b-second spherical ball joint seat
25a-first guide element
25b-second guide element
26a-first translation rail
26b-second translation rail
27a-first guide end
27b-second guide end

1. A clamping device for a braking system configured to exert a relative displacement between friction elements and comprising a caliper supporting at least two hydraulic actuators each configured to provide a clamping force in order to force a relative displacement movement between the friction elements along an axial rectilinear direction, and at least one electric actuator, configured to provide the clamping force and coupled to a mechanism for converting rotational movement of an output shaft of the electric actuator into a translational movement in order to force a relative displacement movement between the friction elements along an axial rectilinear direction, wherein the clamping device comprises a mechanism for balancing the clamping forces of the hydraulic and electric actuators which adapts an orientation of at least one of the friction elements according to its wear, regardless of a type of actuation used.

2. The clamping device according to claim 1, wherein the clamping mechanism comprises a force transmission element mounted between the hydraulic and electric actuators and the friction element in order to receive the clamping forces of the hydraulic and electric actuators to selectively redistribute them in a balanced manner to the friction element.

3. The clamping device according to claim 2, wherein the force transmission element comprises a plate that is articulated relative to at least one of the hydraulic and electric actuators in order to adapt the orientation of the friction element according to its wear, regardless of the type of actuation used.

4. The clamping device according to claim 3, wherein the plate is articulated by a socket connection with clearance in order to only allow rotation about an axis perpendicular to the axial rectilinear direction relative to the electric actuator and by a flat support connection relative to each of the hydraulic actuators in order to adapt the orientation of the friction element according to its wear, regardless of the type of actuation used.

5. The clamping device according to claim 2, wherein the force transmission element redistributes the clamping forces by at least two spherical connections to the friction element in order to adapt the orientation of the friction element according to its wear.

6. The clamping device according to claim 2, wherein the force transmission element receives the clamping force of the electric actuator between the clamping forces of the hydraulic actuators in order to facilitate the balanced redistribution of the clamping forces to the friction element.

7. A braking system for a vehicle comprising a pair of friction elements configured to cooperate by friction with a disc, comprising at least one clamping device according to claim 1 to move the pair of friction elements towards two opposite sides of the disc in order to clamp it.

8. The braking system according to claim 7, wherein the braking system is a floating caliper disc brake.

9. A vehicle comprising the braking system according to claim 7.
